(19) United States
(12) Patent Application Publication
(10) Pub. No.: US 2012/0151546 A1
(43) Pub. Date: Jun. 14, 2012

(54) INFORMATION PROCESSING APPARATUS AND INFORMATION PROCESSING METHOD

(75) Inventors: Toshiki MORI, Tokyo (JP); Shuichi Yamaguchi, Tokyo (JP); Naoko Satoh, Tokyo (JP); Hiroyuki Watanabe, Tokyo (JP)

(73) Assignee: KABUSHIKI KAISHA TOSHIBA, Tokyo (JP)

(21) Appl. No.: 13/204,992

(22) Filed: Aug. 8, 2011

(30) Foreign Application Priority Data
Dec. 10, 2010 (JP) 2010-275862
Jul. 11, 2011 (JP) 2011-153351

(51) Int. Cl. H04N 7/173

(52) U.S. Cl. 725/116

(57) ABSTRACT

An information processing apparatus of one embodiment has: a plurality of processing units; a control unit to control the processing units; and a switch unit having a network switch including a plurality of communication ports to which the processing units and the control unit are connected. Each processing unit transmits an activation completion notification containing an address, a unit-installed position, and a link state to the control unit at the time of activation. The switch unit creates an address learning table associating port identification information indicating the communication ports, addresses of the processing units connected to the communication ports, and link states between the communication ports and the processing units with one another. The control unit creates a unit positional information table associating the port identification information and the unit-installed position with each other based on the contents of the address learning table and the activation completion notification.

### CROSS-REFERENCE TO RELATED APPLICATION(S)

This application is based upon and claims the benefit of priority from the prior Japanese Patent Application No. 2010-275862, filed on Dec. 10, 2010, and the prior Japanese Patent Application No. 2011-153351, filed on Jul. 11, 2011, the entire contents of which are incorporated herein by reference.

### FIELD

The embodiments relate to an information processing apparatus and an information processing method for processing broadcast programs or the contents thereof in a broadcast station, for example.

### BACKGROUND

As seen in the digital broadcasting, digitalization in the broadcasting field has been in progress. Broadcasting systems each sending out programs using the digital broadcasting includes: a video server which stores therein broadcasting programs and the contents thereof; and an automatic program controller which instructs this video server to perform various processes. The video server and the automatic program controller are connected to each other via a network.

Recently, video servers have been required to have an information storing function with a large capacity and a high processing capability. For this reason, the video servers employ a configuration including a plurality of processing units instead of a configuration having a single processing unit. In the vide server configured of a plurality of processing units, each of the processing units includes a CPU (Central Processing Unit) installed therein, and information is communicated between the CPUs via a communication cable.

Also, there is a case where a plurality of video servers are connected to each other via communication cables so as to be utilized as a single video server. In order to connect between the video servers and between the processing units inside the video servers, a LAN (Local Area Network) is used, for example.

If an abnormality such as a communication failure occurs in such video server, the video server needs to promptly identify the abnormal processing unit and to promptly perform recovery by replacement of the abnormal processing unit with a normal processing unit.

If a LAN connects between the video servers and between the processing units of the video servers, a logical connection relationship therebetween can be seen but a physical positional relationship cannot be seen. Thus, if a communication failure occurs within a system, for example, it is difficult to identify the processing unit in which the abnormality has occurred.

### BRIEF DESCRIPTION OF THE DRAWINGS

FIG. 1 shows a schematic configuration of a broadcast program send-out system according to a first embodiment;

FIG. 2 shows a block diagram of a video server;

FIG. 3 shows an example where processing units and a network switch are connected to each other through an inter-unit connection board;

FIG. 4 shows an example of a table showing a relationship between switch port numbers and unit-installed positions;

FIG. 5 shows an example where processing units and a network switch are connected to each other via LAN cables;

FIG. 6 shows an address learning table;

FIG. 7 shows information contained in an activation completion notification to be transmitted from each processing unit;

FIG. 8 shows a unit positional information table;

FIG. 9 shows a flowchart illustrating an operation to be performed when an abnormal situation such as disconnection of a link occurs during communications between processing units;

FIG. 10 shows a configuration of a video server according to a second embodiment;

FIG. 11 shows address learning tables according to the second embodiment;

FIG. 12 shows a connection mode between chassis according to the second embodiment; and

FIG. 13 shows a flowchart illustrating an operation of a CPU of each chassis according to the second embodiment.

### DETAILED DESCRIPTION

An information processing apparatus according to one embodiment has: a plurality of processing units; a control unit configured to control the plurality of processing units; and a switch unit having a network switch including a plurality of communication ports to which the plurality of processing units and the control unit are connected. Each of the processing units is configured to transmit an activation completion notification containing an address on the local area network, a unit-installed position, and a link state to the control unit at the time of activation of the processing unit. The switch unit is configured; to create an address learning table associating port identification information indicating the communication ports, addresses of the processing units connected to the communication ports on the local area network, and link states between the communication ports and the processing units with one another; to transmit the contents of the address learning table to the control unit; and to monitor the link state of each of the communication ports and transmit, when the link state changes from ON to OFF, an alarm notification containing the port identification information of the communication port whose link state is changed, to the control unit. The control unit is configured: to receive the contents of the address learning table; to receive the activation completion notification; to create a unit positional information table associating the port identification information and the unit-installed position with each other based on the contents of the address learning table and the activation completion notification; and to derive, upon receipt of the alarm notification, a unit-installed position of the processing unit connected to the communication port whose link state is changed, based on the port identification information contained in the alarm notification and the unit positional information table.

Referring to the drawings, embodiments of the present invention are described below in detail.

### First Embodiment

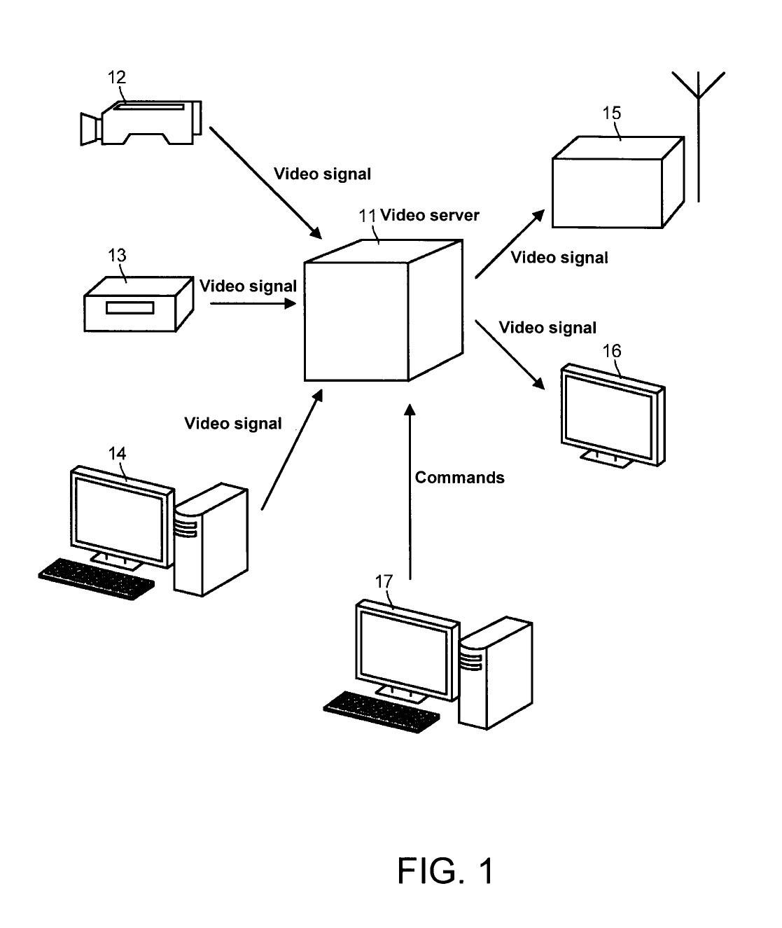

FIG. 1 shows the configuration of a broadcast program send-out system according to a first embodiment. The broadcast program send-out system includes a video server 11 serving as a broadcast information processing apparatus, a camera 12, a playback system 13, a nonlinear editor 14, a broadcast facility 15, and a monitor 16.

The camera 12, the playback system 13, and the nonlinear editor 14 are connected to the video server 11. The video server 11 stores, as video data, video signals of broadcast programs, which are outputted from these devices.

The video server 11 receives an on-air instruction made by a command inputted from a keyboard (not shown) connected to the video server 11 or a command inputted from an operation terminal 17 via a network. The video server 11 selects video data according to the on-air instruction and plays the selected video data, and then outputs the played video signal.

The video data to be played is decoded inside the vide server 11 into a video signal. The video signal is sent out to the broadcast facility 15 and then broadcasted from the broadcast facility 15. Also, the video signal played by the video server 11 is outputted to the monitor 16. The monitor 16 displays the video signal as an image on a screen.

The video server 11 can store a plurality of circuit board units within a chassis. In accordance with the performance required for the video server 11, the numbers of the circuit board units and chassis can be changed. The circuit board units are provided for the respective functions of the video server 11. In the following description, the circuit board units are each referred to as a processing unit.

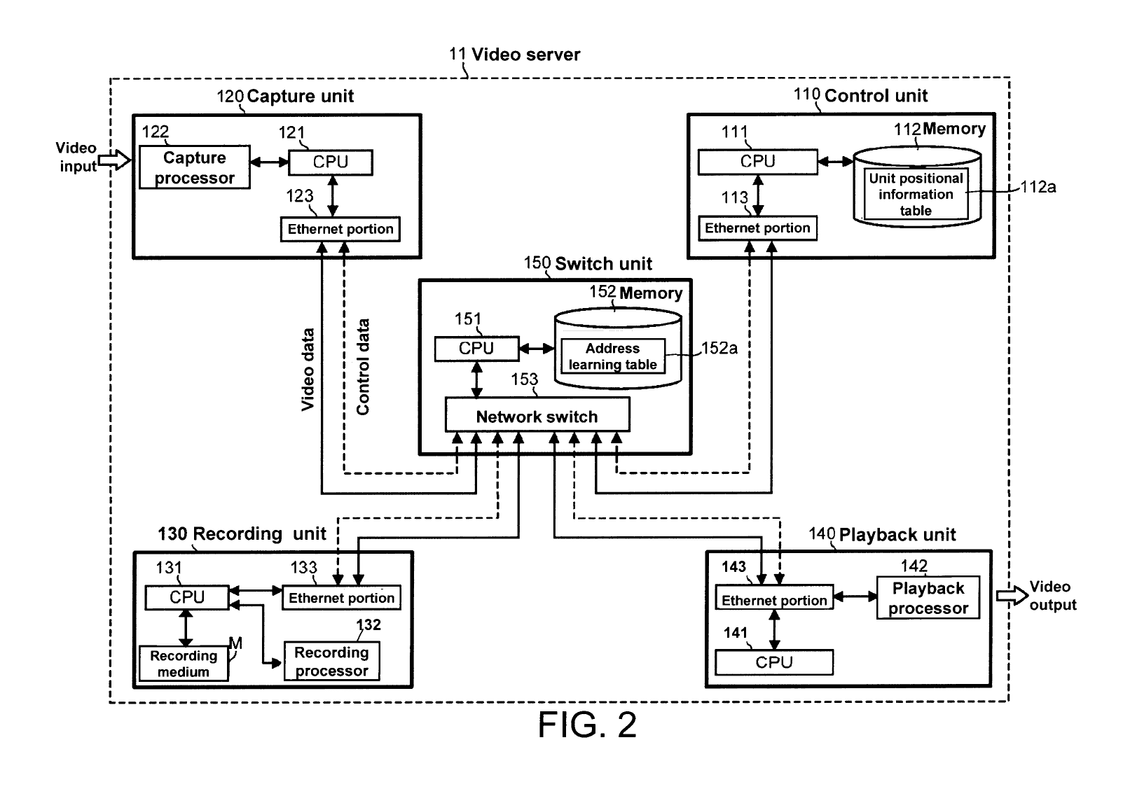

The video server 11 according to the present embodiment includes a plurality of processing units. For example, as shown in FIG. 2, the video server 11 has a control unit 110, a capture unit 120, a recording unit 130, a playback unit 140, and a switch unit 150. Each of the processing units has a CPU.

The processing units are each formed as an independent unit and are connected to each other using a connection board and a cable or a socket.

Hereinafter, each of the processing units is described.

The control unit 110 has a CPU 111, a memory 112, an Ethernet portion 113, and the like, and entirely controls the video server 11. Ethernet is a registered trademark. The Ethernet portion 113 performs packet communications via a LAN. The Ethernet portion 113 is connected to a network switch 153 of the switch unit 150 via the LAN.

The capture unit 120 has a CPU 121, a capture processor 122, an Ethernet portion 123, and the like. The capture unit 120 is connected to the camera 12 and the playback system 13. The capture unit 120 captures a video signal picked up by the camera 12 or a video signal played by the playback system 13, and encodes the video signal and then sends out the encoded video data to the recording unit 130. The Ethernet portion 123 is connected to the network switch 153 of the switch unit 150 via the LAN.

The recording unit 130 has a CPU 131, a recording processor 132, an Ethernet portion 133, and a large-capacity recording medium M such as a flash memory. The recording unit 130 writes the video data sent out from the capture unit 120 to the recording medium M and reads out the video data from the recording medium M, or deletes the video data. The Ethernet portion 133 is connected to the network switch 153 of the switch unit 150 via the LAN.

The playback unit 140 has a CPU 141, a playback processor 142, and an Ethernet portion 143. The playback unit 140 decodes the video data read out from the recording medium M in the recording unit 130 into a video signal and outputs the decoded video signal to a unit in a subsequent stage via a LAN. The Ethernet portion 143 is connected to the network switch 153 of the switch unit 150 via the LAN.

The switch unit 150 has a CPU 151, a memory 152, and the network switch 153. The switch unit 150 is connected to the control unit 110, the capture unit 120, the recording unit 130, and the playback unit 140 via the LAN. The switch unit 150 controls a flow of the video data among the control unit 110, the capture unit 120, the recording unit 130, and the playback unit 140.

The network switch 153 has a plurality of communication ports for network connection. The network switch 153 switches the communication ports among the processing units (the control unit 110, the capture unit 120, the recording unit 130, and the playback unit 140) which are connected respectively to the communication ports for performing communications using the LAN.

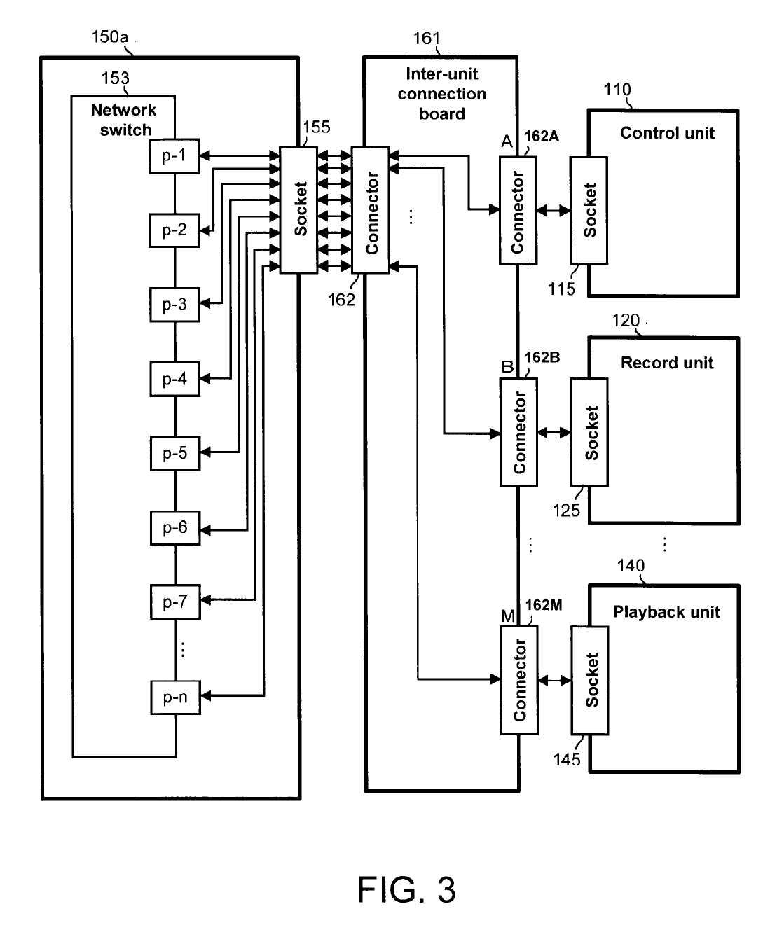

Next, the connection mode of the processing units is described. In an example of the connection mode, as shown in FIG. 3, the processing units (the control unit 110, the capture unit 120, . . . , and the playback unit 140), are connected to a substrate 150a of the switch unit 150 via an inter-unit connection board 161.

In this case, the substrate 150a of the switch unit 150 has a socket 155. Also, the inter-unit connection board 161 has connectors 162, 162A, 162B, . . . , and 162M.

The connector 162 is provided in a position corresponding to the socket 155 of the substrate 150a of the switch unit 150. The connector 162A is provided in a position corresponding to a socket 115 of the control unit 110. The connector 162B is provided in a position corresponding to a socket 125 of the capture unit 120. The connector 162M is provided in a position corresponding to a socket 145 of the playback unit 140.

In this connection mode, the socket 155 of the substrate 150a of the switch unit 150 is connected to the connector 162 of the inter-unit connection board 161. For example, a communication port p-1 of the network switch 153 is connected to the connector 162A of the inter-unit connection board 161 and a communication port p-2 is connected to the connector 162B. In this manner, the communication ports p-1 to p-n of the network switch 153 are fixedly connected to the connectors 162A to 162M of the inter-unit connection board 161, respectively.

In this case, the communication ports p-1 to p-n of the network switch 153 are connected to the processing units 110 to 140 via interconnections formed on the substrate 150a of the switch unit and interconnections formed on the inter-unit connection board 161.

For this reason, the control unit 110 attached to the connector 162A is always connected to the communication port p-1 of the network switch 153 of the switch unit 150. The connection relationship between the processing units and the communication ports remain unchanged unlike the connection relationship formed by cables.

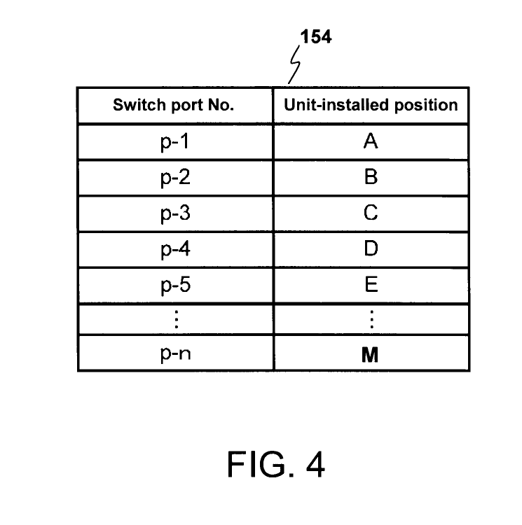

In the connection mode of FIG. 3, unit-installed positions (for example, connector positions A to M) in which the processing units are respectively stored have a fixed connection relationship by port identification information indicating the communication ports of the switch unit 150. The description is given below of the case where the port identification information is switch port numbers. For this reason, as shown in FIG. 4, a table 154 in which the switch port numbers p-1 to p-n of the communication ports of the switch unit 150 are associated with the unit-installed positions A to M is set in the memory 152 at the time of designing a device circuit. The unit-installed positions for the processing units connected to the communication ports are obtained respectively from the switch port numbers of the communication ports by referring to the table 154.

When links between the communication ports p-1 to p-n and the processing units are established, the CPU 151 of the switch unit 150 identifies the unit-installed positions of the processing units, which are the connection destinations of the communication ports, with reference to the table 154 recorded in the memory 152.

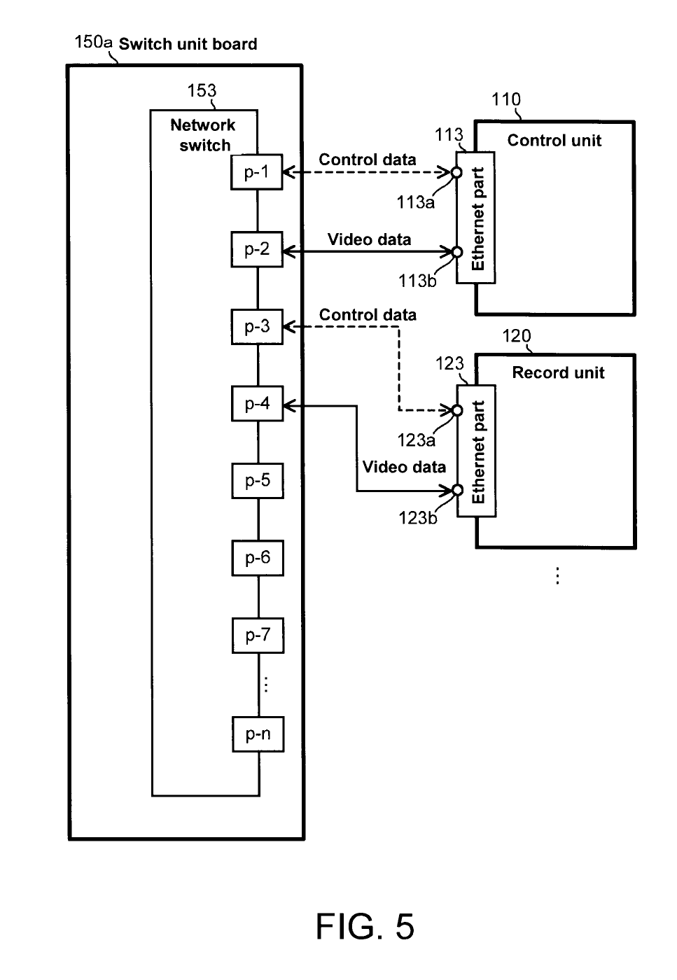

The connection mode of the processing units is not limited to the mode described above. Another connection mode is described, next. For example, in a case where the communication ports of the switch unit 150 and the processing units respectively include general-purpose LAN cable connectors as shown in FIG. 5, the processing units are each connected to any communication port of the network switch 153 not via the inter-unit connection board 161 but via a LAN cable.

In the case of this connection mode, the Ethernet portion 113 of the control unit 110 has a communication port 113a for control data and a communication port 113b for video data.

The Ethernet portion 123 of the capture unit 120 has a communication port 123a for control data and a communication port 123b for video data. The recording unit 130 and the playback unit 140 have communications ports 133a, 143a for control data and communication ports 133b, 143b for video data, respectively, as in the case of the control unit 110 and the capture unit 120.

To put it specifically, the Ethernet portions 113, 123, . . . of the respective processing units have the communication ports 113a, 123a, . . . for control data and the communication ports 113b, 123b, . . . for video data, respectively.

The board 150a of the switch unit 150 has the network switch 153 and the network switch 153 has the plurality of communication ports p-1 to p-n. The communication ports p-1 to p-n are connected to the communication ports of the processing units via LAN cables.

In this connection mode, the connection relationship between the communication ports of the network switch 153 of the switch unit 150 and the processing units is not fixed.

The correspondence relationship between the switch port numbers of the communication ports of the switch unit 150 and the unit-installed positions of the processing units, which are the connection destinations of the communication ports, is obtained in the following manner.

The CPU 151 of the switch unit 150 performs a switching operation of the network switch 153 with an address on the LAN (a MAC address and/or IP address) which is given to each of the processing units connected to the communication ports of the network switch 153. The description is given below of the case where the network switch 153 performs the switching operation with a MAC address.

The MAC address is an address set for a network device, while the IP address is an address of each of the processing units which is assigned to a communication port for network connection. For example, the IP address is derived from an installed-position within a chassis in which each of the processing units is stored. The installed-position of the processing unit is expressed by a position of a connector (for example, a connector name) to which the processing unit is connected, for example.

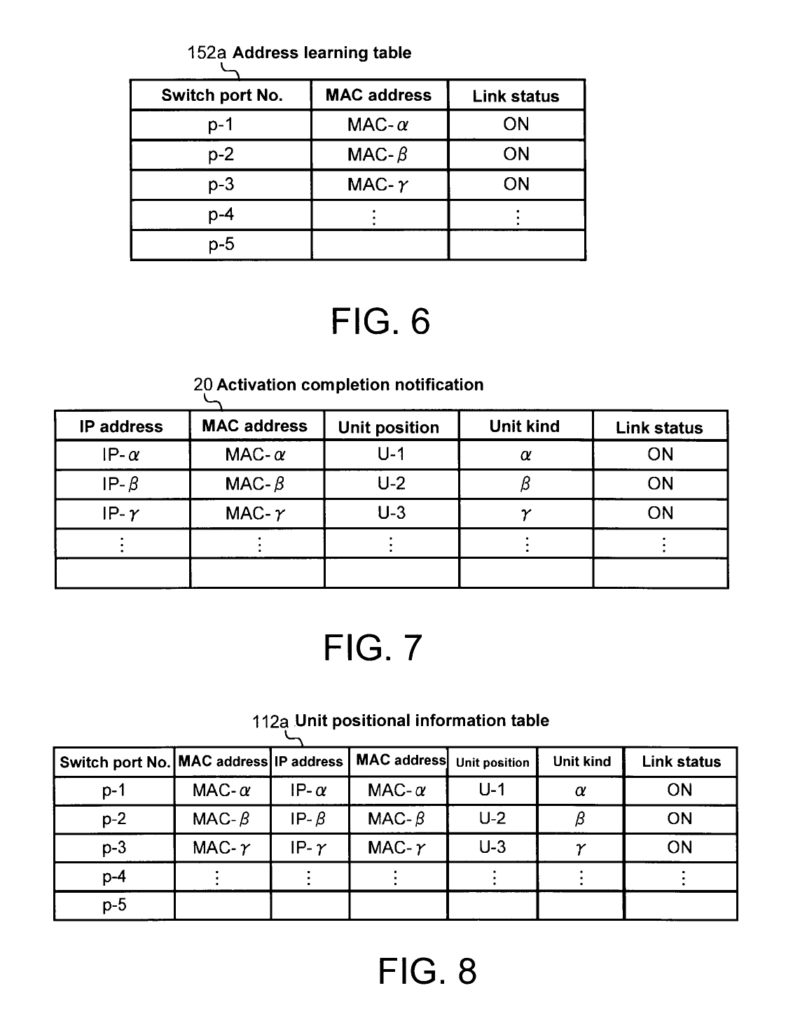

In order for the network switch 153 to perform the switching operation with the MAC address given to the processing unit, the CPU 151 records the MAC address obtained from the processing unit connected to the communication port in the memory 152. At this time, the CPU 151 creates an address learning table 152a shown in FIG. 6 in the memory 152, and records a link state with the processing unit in the address learning table 152a in addition to the MAC address. Note that if the network switch 153 performs a switching operation with an IP address, the CPU 151 may record an IP address as an address of the processing unit on the LAN in the address learning table 152a.

The CPU 151 always monitors the state of the network switch 153 and records connection information (a switch port number and a MAC address of the processing unit of the connection counterpart) with the processing unit which is obtained from the network switch 153 and information on a link state (ON, OFF) with the processing unit of the connection counterpart in a corresponding column in an item of the switch port number in the address learning table 152a.

When a change occurs in the link state, the CPU 151 transmits the contents (information) of the address learning table 152a to the control unit 110. When a change occurs in the link stake, this means that the link state changes from an “ON” state to an “OFF” state or that the link state changes from an “OFF” state to an “ON” state. In other words, when a change occurs in the link state, this means that a link is newly established, or that the link that has been already established with a processing unit is disconnected, to be more specific.

The address learning table 152a shown in FIG. 6 stores the switch port numbers p-1 to p-n of the communication ports of the switch unit 150, the MAC addresses of the Ethernet portions of the processing units, and link states between the communication ports and the processing units.

By referring to the address learning table 152a, the CPU 151 can see that the processing unit having a MAC address “M-a” is connected to the communication port with the switch port number “p-1.”

However, by only referring to the address learning table 152a, the CPU 151 cannot see that the processing unit having the MAC address “M-a” is stored in which position within the video server 11 and that the processing unit is of which kind.

Each of the processing units transmits an activation completion notification indicating that activation is completed to the control unit 110 at the time of activation. As shown in FIG. 7, the activation completion notification 20 includes an IP address and a MAC address as an address on the local area network, the unit-installed position, the unit kind, and the link state. Each of the processing units transmits the activation completion notification about the unit itself to the control unit 110.

The control unit 110 receives the activation completion notification 20 and the contents of the address learning table 152a. Both of the activation completion notification 20 and the address learning table 152a commonly include MAC addresses, so that the CPU 111 of the control unit 110 integrates these pieces of information using the MAC addresses as the key to create a unit positional information table 112a shown in FIG. 8. The CPU 111 stores the created unit positional information table 112a in the memory 112.

The unit positional information table 112a stores switch port numbers, MAC addresses, IP addresses, MAC addresses, unit-installed positions, unit kinds, link states, and the like.

Note that if the address learning table 152a stores the IP addresses of the processing units, the activation completion notification and the contents of the address learning table 152a may be integrated using the IP addresses as the key to create the unit positional information table 112a.

In the unit positional information table 112a, the switch port numbers of the communication ports of the switch unit 150 are associated with the unit-installed positions of the processing units. Thus, in accordance with the unit positional information table 112a, even when the processing units are connected to the communication ports of the switch unit 150 via the LAN cables, the CPU 111 can identify the installed-positions of the processing units connected to the communication ports of the switch unit 150.

Note that every time the CPU 111 of the control unit 110 receives the activation completion notification 20 from each of the processing units, the CPU 111 updates the unit positional information table 112a.

In addition, as described above, the CPU 151 transmits the contents of the address learning table 152a to the control unit 110 when a change occurs in the link states between the communication ports and the processing units. Thus, the CPU 111 of the control unit 110 updates the unit positional information table 112a every time receiving the contents of the address learning table 152a.

Moreover, when a link between a communication port of the switch unit 150 and a processing unit is disconnected, the switch unit 150 detects disconnection of the link and transmits an alarm notification to the control unit 110. The alarm notification includes the switch port number, that is, port identification information of the communication port whose link state with the processing unit changes from an ON-state to an OFF-state. The CPU 111 searches the unit positional information table 112a based on the switch port number contained in the alarm notification and thus can see the processing unit from which the link is disconnected, and the installed-position thereof. The CPU 111 functions as a derivation portion to derive the unit-installed position of the processing unit whose link state is changed.

The link state of the communication port of the switch unit 150 is ON when the processing unit connected to the communication port operates normally. Meanwhile, the link state of the communication port is OFF when the processing unit is not connected to the communication port or when there is a device failure or the like. Since the CPU 151 of the switch unit 150 monitors the link states of the communication ports, if the link state of the communication port changes from ON to OFF, it can be seen that communications with the processing unit connected to this communication port cannot be performed. In this case, the CPU 151 performs processing to be performed when an abnormal situation occurs.

Incidentally, there is a case where some of the processing units are removed from the connector for maintenance operation of the video server or the like. In this case, a change in the link state from ON to OFF cannot be said to be an abnormal situation. Thus, it is improper to perform the processing to be performed when an abnormal situation occurs. The maintenance operation to remove a processing unit from the connector is not performed when the service is in operation. Therefore, the operation to remove a processing unit from the connector is performed after the operation state of the target processing unit is changed from in-service to out-of-service.

The processing unit which is a target for maintenance notifies other processing units that its operation state is in the out-of-service state. Upon receipt of this out-of-service notification, the CPU 111 of the control unit 110 can detect that which processing unit has changed in the out-of-service state from the unit positional information table 112a shown in FIG. 8.

The control unit 110 can see whether each of the processing units connected to the network switch 153 is in the in-service state or the out-of-service state. Thus, only an abnormal communication occurring when the operation state is in the in-service state is treated as an error, while an abnormal communication occurring when the operation state is in the out-of-service state is not treated as an error. For example, an abnormal communication caused by removing a processing unit in the out-of-service state is not treated as an error.

As described above, the CPU 151 of the switch unit 150 monitors the link state of each of the communication ports of the network switch 153. The CPU 151 functions as a monitoring portion which monitors the link state of each of the communication ports. With this configuration, the CPU 151 can quickly detect an occurrence of an abnormal communication of the processing unit connected to the communication port.

Note that, even in a case where an abnormal communication occurs due to a failure of a processing unit or the like, if the switch unit 150 cannot detect that the link state of the processing unit is now OFF, the switch unit 150 cannot see the occurrence of the abnormal communication.

In the present embodiment, as shown in FIG. 5, each of the processing units has a communication port for control data for controlling the operation of the processing unit and a communication port for video data.

Accordingly, the switch unit 150 monitors the link state of each of the communication ports of the network switch 153. When an abnormality is detected in a communication path for control data, the control unit 110 can notify the processing unit of the occurrence of the abnormality via a communication path for video data. On the other hand, when the switch unit 150 detects an abnormality in the communication path for video data, the control unit 110 can notify the processing unit of the occurrence of the abnormality via the communication path for control data.

In this manner, notification means via another path is secured for the processing unit in which an abnormality occurs, so that the opportunity that the processing unit can perform processing correctly when an abnormality occurs is increased. Thus, the operation stability of devices can be increased.

Next, the normal operation of this broadcast program send-out system is described. When a video signal picked up by the camera 12 is recorded in the video server 11, the control unit 110 transmits a control signal to the capture unit 120 to instruct the capture unit 120 to capture the video signal.

In the capture unit 120, the CPU 121 encodes the video signal picked up by the camera 12 into video data in a compression coding format, such as MPEG2 in accordance with the instruction from the control unit 110.

In addition, when transmitting the control signal to the capture unit 120, the control unit 110 also transmits a control signal to the recording unit 130 at the same time so as to instruct the recording unit 130 to write the video data therein. In accordance with this instruction, in the recording unit 130, the CPU 131 writes the video data encoded by the capture unit 120 in the recording medium M.

When the video data recorded in the recording medium M is played, the control unit 110 transmits a control signal to the recording unit 130 so as to instruct the recording unit 130 to read out the video data. With this instruction, in the recording unit 130, the CPU 131 reads out the video data from the recording medium M and transmits the read video data to the playback unit 140.

Moreover, when transmitting the control signal to the recording unit 130, the control unit 110 also transmits a control signal to the playback unit 140 at the same time so as to instruct the playback unit 140 to decode the video data. In accordance with this instruction, in the playback unit 140, the CPU 141 decodes the video data in the MPEG2 format, which is received from the recording unit 130, into the video signal and outputs the decoded video signal.

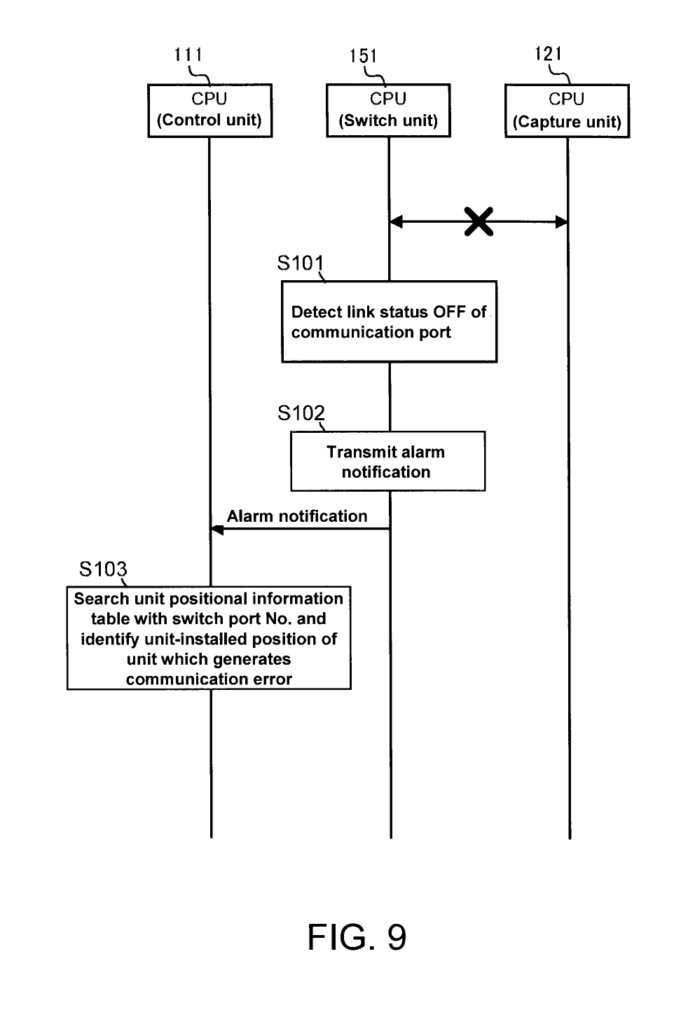

Next, referring to FIG. 9, a description is given of an operation performed when an abnormality such as disconnection of a link occurs during communications between the processing units.

For example, after a link between the switch unit 150 and the capture unit 120 is established, disconnection of the link occurs between those units. Then, the CPU 151 of the switch unit 150 detects that a link state of a communication port of the network switch 153 is OFF (step S101).

After that, the CPU 151 creates an alarm notification containing a switch port number of the communication port whose link state has become OFF. Then, the CPU 151 transmits the alarm notification to the control unit 110 via the LAN (step S102).

Upon receipt of the alarm notification via the Ethernet portion 113, the CPU 111 of the control unit 110 searches the unit positional information table 112a using the switch port number contained in the alarm notification as the key. Also, the CPU 111 identifies the unit-installed position (for example, a connector name) of the processing unit in which a communication abnormality has occurred from the unit positional information table 112a and then triggers an alarm. Moreover, the CPU 111 updates the link state of the processing unit in the unit positional information table 112a based on the contents of the address learning table which are notified from the switch unit 150.

A warning light is provided in the switch unit 150 for each unit-installed position for the processing unit, for example. As an example of the alarm warning operation, the warning light is turned on. The turned-on warning light indicates the unit-installed position of the processing unit whose link state has become OFF. During the alarm warning operation, a message containing such pieces of information as the kind of the processing unit whose link state has become OFF, the unit-installed position of the processing unit, and a failure state where the link state has become OFF and the like, may be transmitted to a predetermined electronic mail address.

Next, a method of determining an unused port is described.

The CPU 151 of the switch unit 150 can determine a link state for each communication port of the switch unit 150 and can determine if an abnormality occurs for each communication port of the switch unit 150. The CPU 151 measures a duration while the link-off state of the communication port has continued since the device is activated. If the link-off state continues more than a predetermined period of time, the CPU 151 determines that the communication port is an unused port to which no processing unit is connected.

The CPU 151 of the switch unit 150 performs control so that a power supply is turned off for the communication port which is determined as unused. The turning off of the power supply for the communication port determined as unused can reduce the power consumption of the device without losing the function of the device.

Meanwhile, the CPU 151 supplies the communication port which is determined as unused and is turned off with power for every predetermined time to determine whether the link state has become ON. If the link state does not become ON during a predetermined time for supplying the power, the power supply is turned off again.

Also, if the link state becomes ON after a periodic power supply to the communication port, the CPU 151 continues the power supply state without any change. If the link state becomes ON, the CPU 151 determines that a connected device exists. Thus, even when a processing unit is added after the device is activated, power is supplied to the communication port corresponding to the added processing unit. In this manner, power is periodically supplied to a communication port of the network switch 153, and thereby, the link state is periodically checked. As a result, the power consumption of the network switch 153 can be reduced and, at the same time, additional connection of a processing unit can be handled.

In addition, as shown in FIG. 5, when each processing unit has two kinds of communication ports, one for control data and the other for video data and the communication ports of the network switch are configured in advance so as to be used in pair for a single processing unit, the CPU 151 periodically supplies power to only one of the communication ports of the network switch for control data and for video data.

In other words, when the configuration is such that a new processing unit is additionally connected to the pair of the communication ports with the switch port numbers p-5 and p-6 in the connection state of the processing units shown in FIG. 5, power is periodically supplied only to the communication port for control data with the switch port number p-5. The CPU 151 performs control so that power is also supplied to the communication port for video data with the switch port number p-6 only when the link state becomes ON. With this operation, the unused communication port for video data is always turned off, and, thus, the time period for supplying power to the unused port can be shortened. Consequently, the power consumption can be reduced. Note that, meanwhile, the link state may be determined by periodically supplying power only to the communication port for video data. When the link state becomes ON, power is also supplied to the communication port for control data in this case.

As described above, according to the first embodiment, when each processing unit is activated, the switch unit 150 creates an address learning table 152a in which switch port numbers respectively indicating communication ports of the network switch 153, addresses of the processing units connected to the communication ports on the network, and link states of the communication ports are associated with one another, and records the address learning table 152a in the memory 152. Also, the switch unit 150 transmits the contents of the address learning table 152 to the control unit 110. Each processing unit transmits an activation completion notification to the control unit 110 at the time of activation. The activation completion notification contains an IP address, MAC address, unit-installed position, unit kind, and link state of the processing unit. The control unit 110 creates a unit positional information table 112a based on the address learning table 152a and the activation completion notification 20 and records the unit positional information table 112a in the memory 112.

When the link state of a communication port of the network switch 153 changes from ON to OFF, the CPU 151 creates an alarm notification containing the switch port number of the communication port whose link state is changed, and transmits the alarm notification to the control unit 110. In the control unit 110, the unit positional information table 112a is searched by using the switch port number contained in the received alarm notification as the key to identify an installed-position of the processing unit in which an abnormal communication has occurred and then triggers an alarm. With this operation, a user can easily identify the position where a failure has occurred. Accordingly, with regard to a failure such as an abnormal communication which occurs during communications between the processing units connected to each other via a LAN, an exchange of the processing unit or the like can be quickly performed. Consequently, an early recovery from the failure can be made.

In the first embodiment, the description is given of the example where the video server has the control unit 110 and the switch unit 150. However, the video server may have one processing unit provided with functions of the control unit 110 and the switch unit 150. The processing unit is named as a control and switch unit, for example.

Also, in the first embodiment, the processing units of the video server 11 are stored in one chassis. However, processing units stored in a different chassis or another video server may be connected to the network switch 153 via a LAN cable. In this case, one video server is configured of a plurality of chassis.

### Second Embodiment

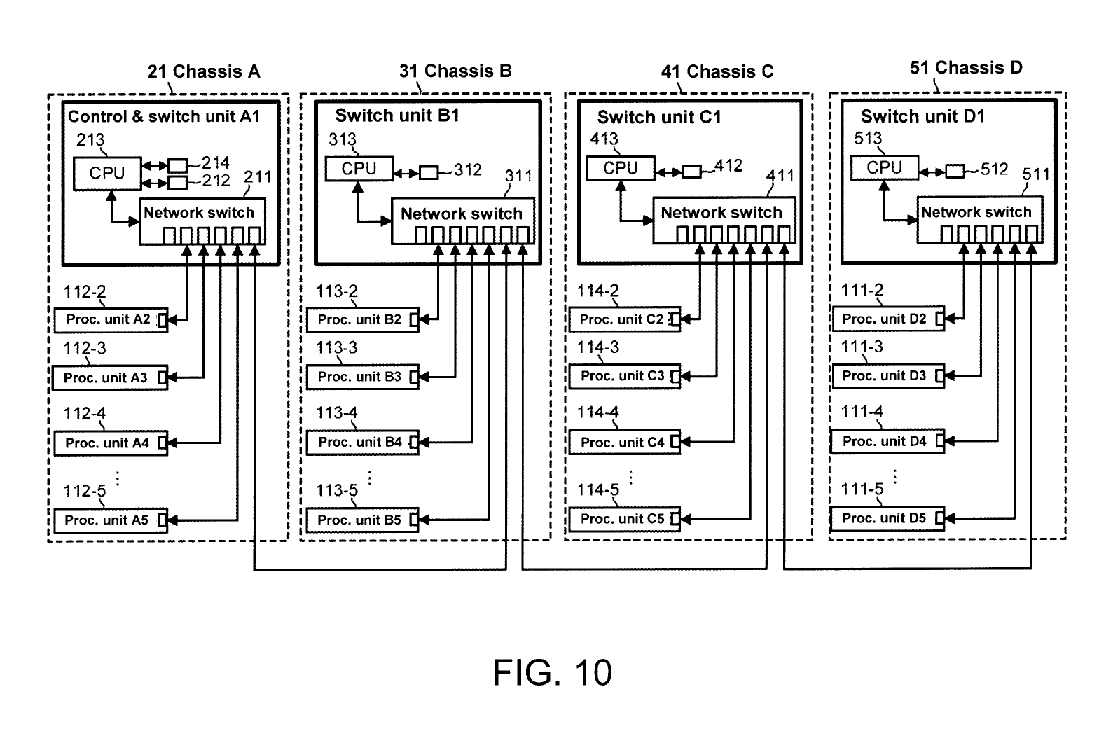

FIG. 10 shows the configuration of a video server according to a second embodiment. As shown in FIG. 10, the video server of this second embodiment includes a plurality of video servers shown in FIG. 2. In other words, the plurality of video servers configures one video server.

The video server according to the second embodiment has four chassis: a chassis A, a chassis B, a chassis C, and a chassis D. Each of the chassis A to D has the same configuration. The chassis A stores therein a plurality of processing units A1 to A5. Here, the description is given of a case where the five processing units A1 to A5 are provided in a single chassis.

The processing unit A1 is a control and switch unit in which a control unit and a switch unit are integrated and which integrally controls an entire system. Other than the processing unit A1, the processing units A2 to A 5 are each a processing unit which individually operates inside the chassis A.

The control and switch unit A1 includes a network switch 211, an address learning table 212, a CPU 213, a unit positional information table 214 and the like.

The chassis B has a switch unit B1 and processing units B2 to B5. The switch unit B1 includes a network switch 311, an address learning table 312, a CPU 313, and the like.

The chassis C has a switch unit C1 and processing units C2 to C5. The switch unit C1 includes a network switch 411, an address learning table 412, a CPU 413, and the like.

The chassis D has a switch unit D1 and processing units D2 to D5. The switch unit D1 includes a network switch 511, an address learning table 512, a CPU 513, and the like.

The network switches 211, 311, 411, and 511 respectively provided in the chassis A to D are connected to all the processing units within the same chassis. For example, the network switch 211 is connected to the processing units A2 to A5. The network switch 311 is connected to the processing units B2 to B5. The network switch 411 is connected to the processing units C2 to C5. The network switch 511 is connected to the processing units D2 to D5.

Also, the network switch 211 is connected to the network switch 311, the network switch 311 is connected to the network switch 411, and the network switch 411 is connected to the network switch 511. A single chassis may store therein only the same kind of processing units or different kinds of processing units.

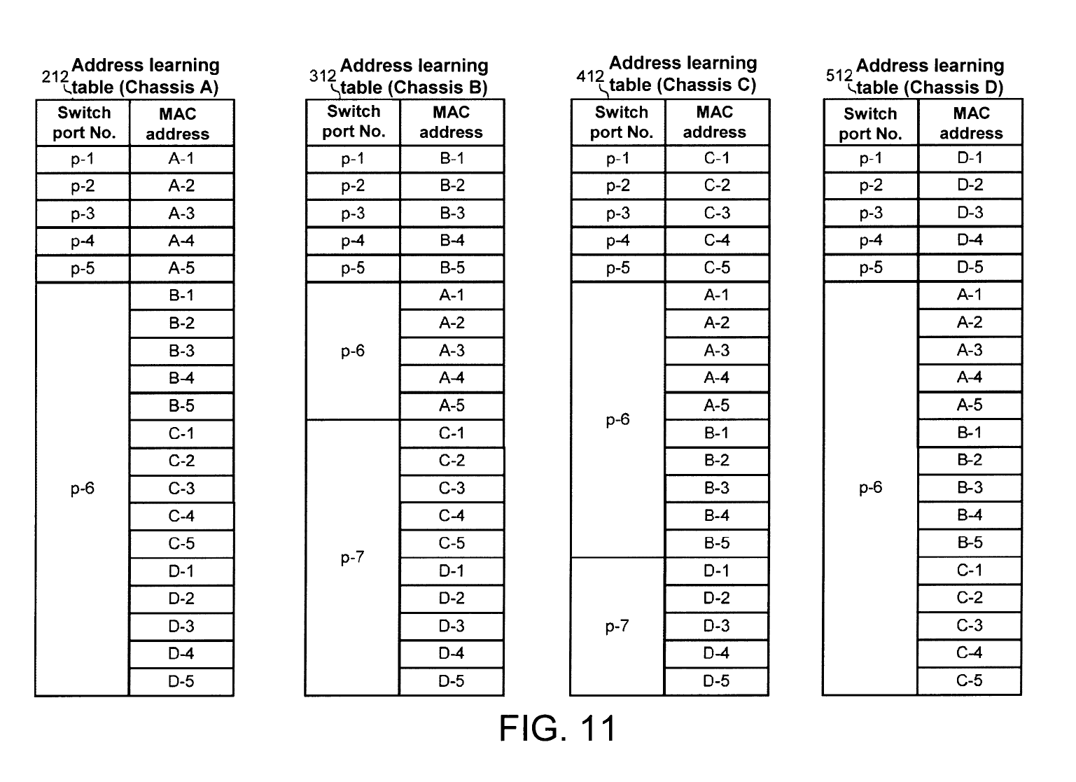

FIG. 11 shows address learning tables. Reference numeral 212 shows an address learning table created by the CPU 213 of the control and switch unit A1 in the chassis A. Reference numeral 312 shows an address learning table created by the CPU 313 of the switch unit B1 in the chassis B. Reference numeral 412 shows an address learning table created by the CPU 413 of the switch unit C1 in the chassis C. Reference numeral 512 shows an address learning table created by the CPU 513 of the switch unit D1 in the chassis D.

If the chassis A to D are connected as shown in FIG. 10, in the address learning table 212, a MAC address “A-1” of the processing unit A1 is registered in a switch port number “p-l” in the chassis A. Similarly, in the chassis A, a MAC address “A-2” of the processing unit A2 is registered in a switch port number “p-2,” a MAC address “A-3” of the processing unit A3 is registered in a switch port number “p-3,” a MAC address “A-4” of the processing unit A4 is registered in a switch port “P-4,” and a MAC address “A-5” of the processing unit AS is registered in a switch port number “p-5.”

In the switch port number “p-6,” MAC addresses of all the processing units in the chassis B, C, and D are registered.

Similar to the address learning table 212 in the chassis A, in each of the address learning tables 312, 412, and 512 in the chassis B, C, and D, switch port numbers in a corresponding one of the chassis and MAC addresses of the processing units are registered.

The network connecting between the processing units and between the chassis is a network closed inside the device. Accordingly, local addresses of a MAC address and an IP address can be freely set as long as they are unique inside the device.

In the second embodiment, a chassis ID which is an individual identifier is assigned to each chassis. For example, a chassis ID value is set using the network switch provided in the chassis.

Each processing unit can recognize the chassis ID with reference to the state of the network switch. In addition, the ID number is used for determining the MAC address and the IP address. For this reason, the chassis ID can be calculated from the MAC address and the IP address. For example, the lower 16 bits of an address portion are used for the chassis ID number.

As described above, the MAC address is caused to have an association with the chassis ID. As a result, the chassis storing therein a switch unit can be determined based on the MAC addresses registered in each of the address learning tables 212 to 512 of the switching units.

The CPU 213 of the control and switch unit A1 in the chassis A reads out the registered contents of the address leaning tables 312 to 512 and gathers the registered contents of the address learning tables 312 to 512 via a LAN.

With this operation, the CPU 213 can see from the contents of the address learning table 212 that the chassis B, C, and D are connected to the“p-6” port of the chassis A, for example. Similarly, the CPU 213 can see from the contents of the address learning table 312 that the chassis A is connected to the “p-6” port of the chassis B and the chassis C and D are connected to the “p-7” port. The CPU 213 can also see from the contents of the address learning table 412 that the chassis A and B are connected to the “p-6” port of the chassis C, and the chassis D is connected to the “p-7” port. The CPU 213 can see from the contents of the address learning table 512 that the chassis A, B and C are connected to the “p-6” port of the chassis D.

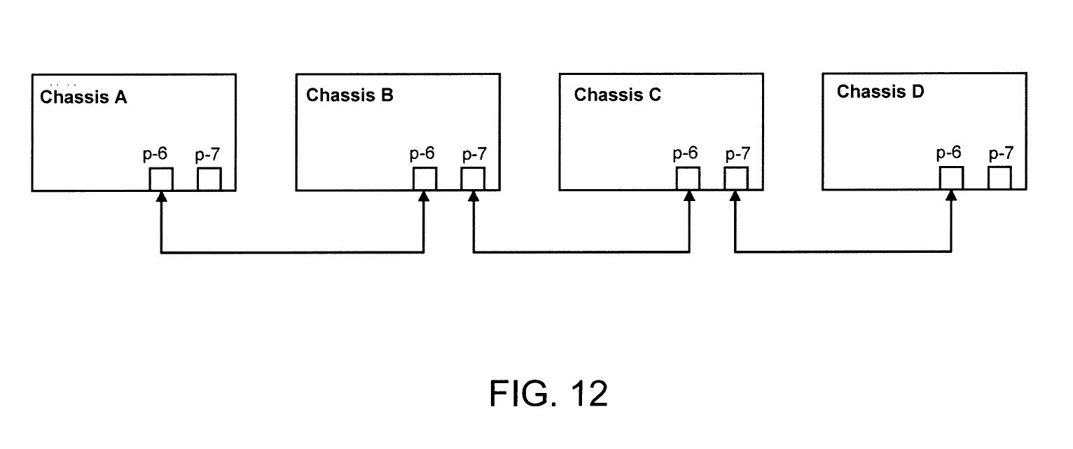

Moreover, as shown in FIG. 12, with regard to the connection mode of the chassis, it can be seen without checking an actual connection state of the LAN cables by sight that the “p-6” port of the chassis A and the “p-6” port of the chassis B are connected to each other, the “p-7” port of the chassis B and the “p-6” port of the chassis C are connected to each other, and the “p-7” port of the chassis C and the “p-6” port of the chassis D are connected to each other.

The CPU 213 controlling the entire device determines the connection state of the LAN. The processing units are connected to one another through the network. Thus, the CPU 213 can determine the connection state of the LAN by gathering the information on all the network switches gathered in each of the chassis A to D to the CPU 213 of the control and switch unit A1.

In addition, the CPU 213 of the control and switch unit A1 creates a unit positional information table 214 based on the contents of the address learning table of each of the chassis and an activation completion notification to be described below. The unit positional information table 214 allows the CPU 213 to identify a communication port and an installed-position of the processing unit connected to the communication port.

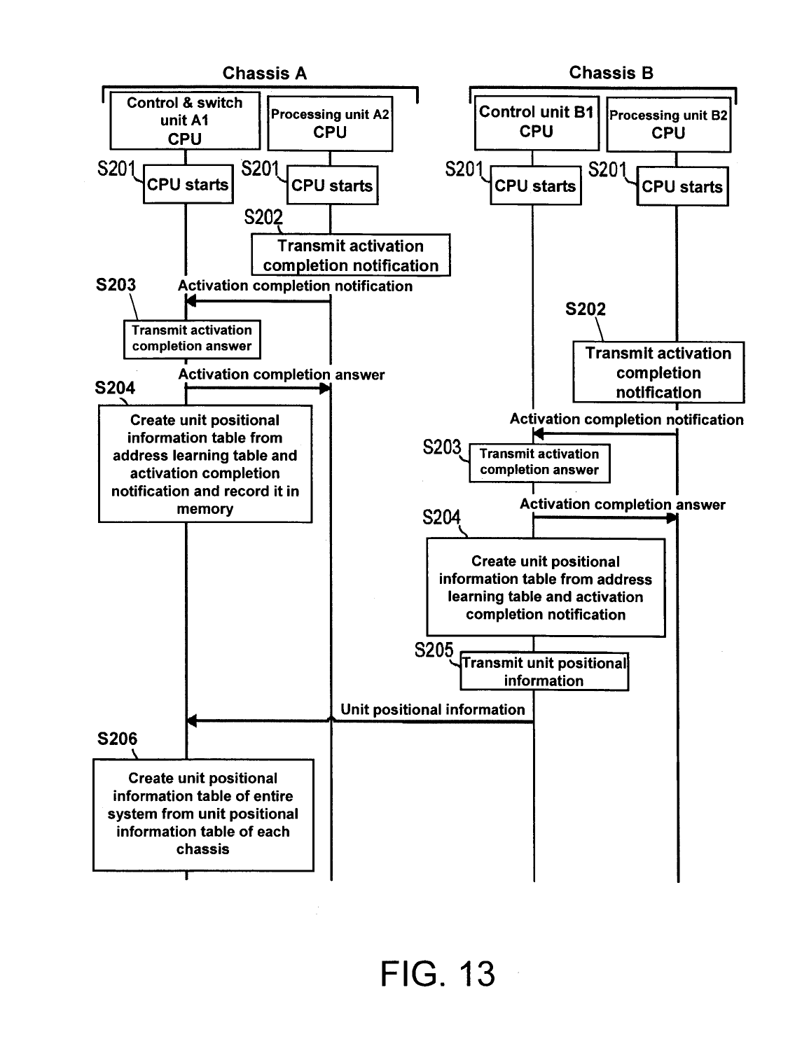

Referring to FIG. 13, the description is given of a specific example of an operation in which the control and switch unit A1, and switch units B1, C1 and D1 in the respective chassis are activated. In this case, when power is supplied to the chassis A to D, the CPU 213 of the control and switch unit A1, the CPU of the processing unit A2, . . . , the CPU of the processing A5 are activated (Step S201). After that, the activation completion notification is transmitted from the CPU of the processing unit A2 to the CPU 213 of the control and switch unit A1 (Step S202). Similar to the first embodiment, the activation completion notification contains an IP address, MAC address, unit-installed position in the chassis, unit kind, link state of the processing unit and the like.

The CPU 213 of the control and switch unit A1 having received the activation completion notification transmits an activation completion answer as an answer to the activation completion notification to the processing unit A2 (Step S203).

Subsequently, the CPU 213 of the control and switch unit A1 creates a unit positional information table from the contents of the address learning table and the information contained in the activation completion notification received from the CPU of the processing unit A2 and records the unit positional information table in the memory (Step S204). A processing similar to that performed on the processing unit A2 is performed on the processing units A3, A4, and A5.

When power is supplied to the chassis B, the CPU 313 of the switch unit B1, the CPU of the processing unit B2, . . . , and the CPU of the processing unit B5 are activated in the chassis B (Step S201). After that, an activation completion notification is transmitted to the CPU 313 of the switch unit B1 from the CPU of each of the processing units (Step S202).

The CPU 313 of the switch unit B1 having received the activation completion notification transmits an activation completion answer as an answer to the activation completion notification to the processing unit from which the activation completion notification is received (Step S202).

Subsequently, the CPU 313 of the switch unit B1 creates a unit positional information table from the contents of the address learning table and the information contained in the activation completion notification received from the CPU of the processing unit B2 (Step S204). After that, the CPU 313 transmits the unit positional information which is included in the unit positional information table to the control and switch unit A1 (Step S205). A processing similar to that performed on the processing unit B2 is performed on the processing units B3, B4, and B5.

Also, a processing similar to that performed on the chassis B is performed on the chassis C and D.

In the control and switch unit A1, upon receipt of the contents of the unit positional information tables from the chassis B to D, the CPU 213 uses the contents of the unit positional information received from the chassis B to D and the unit positional information of the chassis A itself which is recorded in the memory, then, creates a unit positional information table of the entire system configured of the plurality of chassis and then records the unit positional informational table in the memory (Step S206).

The unit positional information table of the entire system is created as described above, so that the plurality of chassis configuring the system and the installed-positions of the processing units stored in each of the chassis can be identified. Also, the connection modes between the chassis can be determined based on the unit positional information table of the entire system.

Note that the address learning tables 212 to 512 of the chassis A to D are updated every time a change in the link state of each of the communication ports of the network switch in each of the chassis is detected. Also, the unit positional information tables of the chassis A to D are updated every time a change in the link state of each of the communication ports of each of the network switches in the respective chassis is detected.

Moreover, every time the link state of a communication port of the own network switch changes from ON to OFF, the CPU of the switch unit in each of the chassis B to D transmits an alarm notification containing identification information of the communication port whose link state is changed to the CPU 213 of the control and switch unit A1. The CPU 213 of the control and switch unit A1 can identify the processing unit connected to the communication port whose link state is changed to OFF, based on the alarm notification and the unit positional information table. Similarly, when the link state of a communication port of the own network switch is changed from ON to OFF, the CPU 213 of the control and switch unit A1 in the chassis A can identify the processing unit connected to the communication port whose link state is changed to OFF, based on the identification information of the communication port whose link state is changed and the unit positional information table. As a result, the CPU 213 of the control and switch unit A1 can identify the processing unit connected to the communication port whose link state is changed from ON to OFF and the installed-position of the processing unit. In addition, the CPU 213 of the control and switch unit A1 triggers an alarm when the link state is changed from ON to OFF.

In addition, the video server can recognize the connection modes of the chassis A to D, as described above, so that the video server can see the range of influence when a failure occurs in the chassis C, for example.

In a case where a failure occurs in the network switch 411 in the chassis C while the control and switch unit A1 performing the control of the entire video server is stored in the chassis A as in the example shown in FIG. 10, for example, the communications between the chassis A and the chassis C, and D are disconnected and the link states for the communications become OFF.

Meanwhile, since no failure occurs in the communications between the chassis A and B, the CPU 213 in the chassis A can take a measure such that the processing using the chassis C and D is stopped to maintain the functions as a system by using only the chassis A and B.

As described above, if disconnection of a link occurs in one of the plurality of the chassis connected via the LAN, communications with the chassis connected after the one of the chassis are affected. For this reason, to know the connection mode between the chassis can be used, for example, for determining the order of stopping the chassis for each chassis at the time of the stop processing of the video server.

As for the stop processing of the video server, the stop processing is started when the control and switch unit A1 transmits a stop instruction to each of the processing units. However, if one of the chassis in the middle of the connections is stopped, the communications between the chassis connected after the one of the chassis and the chassis A are disconnected. Thus, the information on the connection mode is used to perform the stop processing from the end of the network. As a result, the problem of disconnected communications can be avoided.

For example, in the example of FIG. 12, in the case where the control and switch unit A1 is stored in the chassis A, it is only needed to stop the chassis C after the chassis D is stopped, and furthermore, to perform the stop processing on the chassis B and the chassis A in this order.

As described above, according to the second embodiment, address learning tables 212 to 512 in which MAC addresses or IP addresses respectively identifying a plurality of processing units are associated with communication ports are provided respectively in a plurality of chassis A, B, C, and D. The chassis A including the CPU 213 gathers the unit positional information tables of the processing units from the chassis B, C, and D via the network, and creates a unit positional information table 214 of the entire system from these unit positional information tables. Every time the link state of a communication port of the network switch changes from ON to OFF, the CPU 213 of the control and switch unit A1 can identify the installed-position of the processing unit connected to the communication port whose link state is changed, based on the identification information of the communication port whose link state is changed and the unit positional information table 214.

In addition, the unit positional information table 214 allows the connection state from the chassis A to the chassis D to be checked without following the LAN wiring from the chassis A to the chassis D. Thus, maintainability can be improved.

Moreover, in the second embodiment, when a chassis in the middle of the connections is turned off, communications between a chassis connected after the one of chassis and the chassis A are affected. Thus, the stop processing is performed from the end of the network by use of the information on the connection state. Consequently, a problem that power of an undesired chassis is turned off can be avoided.

Furthermore, according to the second embodiment, the network connecting from the chassis A to the chassis D is a network closed in the apparatus. As long as the network is closed in the apparatus, a MAC address/an IP address can be freely set within a range of “address allocation rules” in which a chassis ID is used for determining a MAC address/IP address.

Also, the connection mode of the chassis A to D is not limited to the connection mode shown in FIG. 12 in which the chassis A to D are connected in series. For example, each of the chassis B to D may be directly connected to the chassis A.

The information processing apparatus according to at least one of the above-described embodiments can identify a unit-installed position of a processing unit connected to a communication port whose link state is changed.

Some embodiments of the present invention have been described above. However, these embodiments are disclosed as an example and are not intended to limit the scope of the present invention. These new embodiments can be implemented in other various modes, and various omissions, replacements, and modifications are possible without departing from the spirits of the invention. These embodiments and their modifications are included in the scope and the gist of the invention and in the invention described in the scope of claims and their equivalents.

Also, the component elements shown in the above-described embodiments may be implemented by a program installed in a storage such as a hard disk device of a computer. Alternatively, the functions of the present invention are implemented by a computer in such a manner that a program is stored in computer readable electronic media and the computer is caused to read the program from the electronic media. The electronic media includes, for example, recording media such as CD-ROM, flash memory, removable media, or the like. Furthermore, the functions of the present invention may be implemented in such a manner that the component elements are stored in a distributed manner in different computers connected via a network and then communications are performed among the computers causing the components to function.

What is claimed is:

1. An information processing apparatus comprising:
a plurality of processing units;
a control unit configured to control the plurality of processing units; and
a switch unit having a network switch including a plurality of communication ports to which the plurality of processing units and the control unit are connected, the network switch being configured to switch between the plurality of communication ports in order to perform communications between the control unit and the plurality of processing units via a local area network, wherein
a) each of the processing units is configured to transmit an activation completion notification containing an address on the local area network, a unit-installed position, and a link state to the control unit at the time of activation of the processing unit,
b) the switch unit is configured:
to create an address learning table associating port identification information indicating the communication ports, addresses of the processing units connected to the communication ports on the local area network, and link states between the communication ports and the processing units with one another;
to transmit the contents of the address learning table to the control unit; and
to monitor the link state of each of the communication ports and transmit, when the link state changes from ON to OFF, an alarm notification containing the port identification information of the communication port whose link state is changed, to the control unit, and
c) the control unit is configured:
to receive the contents of the address learning table;
to receive the activation completion notification;
to create a unit positional information table associating the port identification information and the unit-installed position with each other based on the contents of the address learning table and the activation completion notification; and
to derive, upon receipt of the alarm notification, a unit-installed position of the processing unit connected to the communication port whose link state is changed, based on the port identification information contained in the alarm notification and the unit positional information table.

2. The information processing apparatus according to claim 1, wherein once deriving the unit-installed position of the processing unit connected to the communication port whose link state is changed, the control unit identifies the derived unit-installed position and triggers an alarm.

3. The information processing apparatus according to claim 2, wherein the control unit turns on a warning light showing the unit-installed position of the processing unit connected to the communication port whose link state is changed.

4. The information processing apparatus according to claim 2, wherein the control unit transmits a message containing the unit-installed position of the processing unit connected to the communication port whose link state is changed to an electronic mail address set in advance.

5. The information processing apparatus according to claim 1, wherein the switch unit is configured to turn on and off power for each of the communication ports of the network switch, to measure a duration while the link state is OFF, and to turn off the power of the communication port whose duration while the link state is OFF continues for a certain period of time.

6. The information processing apparatus according to claim 5, wherein the switch unit periodically turns on the power of the communication port whose power is turned off, then checks the link state of the communication port, then continues a power-on state for the communication port when the link state of the communication port is ON, and turns off the power of the communication port again when the link state of the communication port continues to be OFF for a certain period of time.

7. The information processing apparatus according to claim 1, wherein
each of the processing units has a first communication port and a second communication port, and
the switch unit monitors link states of the communication ports of the network switch which are connected respectively to the first communication port and the second communication port, and once detecting a change from ON to OFF in the link state of any one of the communication ports, notifies the processing unit that an abnormality is detected, by using the communication port for which no change in the link state is detected.

8. An information processing apparatus, comprising:
a network switch having a plurality of communication ports and being configured to switch between the plurality of communication ports in order to perform communications between a plurality of processing units connected to the plurality of communication ports via a local area network;
a plurality of processing units connected to the plurality of communication ports of the network switch, each of the processing units transmitting an activation completion notification containing an address on the local area network, a unit-installed position, and a link state to a derivation portion via the local area network at the time of activation of the processing unit;
a memory configured to store therein an address learning table associating port identification information indicating the communication ports of the network switch, addresses of the processing units on the local area network, and link states between the communication ports and the processing units with one another;
a monitoring portion configured such that the monitoring portion monitors the link state of each of the communication ports of the network switch; and once detecting a change from ON to OFF in the link state between the communication port and the processing unit, the monitoring portion transmits an alarm notification containing the port identification information of the communication port whose link state is changed, to the derivation portion; and
the derivation portion configured to create a unit positional information table associating the port identification information and the unit-installed position of the processing unit with each other based on the contents of the address learning table and the activation completion notification, and to derive, upon receipt of the alarm notification, the unit-installed position of the processing unit connected to the communication port whose link state is changed, with reference to the unit positional information table.

9. The information processing apparatus according to claim 8, further comprising:
another network switch having a plurality of other communication ports; and
a plurality of other processing units connected to the plurality of other communication ports, wherein one of the plurality of other communication ports is connected to one of the plurality of communication ports of the network switch.

10. An information processing method using an information processing apparatus configured to perform communications via a local area network between processing units connected to a plurality of communication ports of a network switch, the information processing method comprising the steps of:
creating an activation completion notification containing an address of each of the processing units on the local area network and a unit-installed position of the processing unit at the time of activation of the processing unit;
creating an address learning table associating port identification information indicating the communication ports connected to the processing units, addresses of the processing units on the local area network, and link states between the communication ports and the processing units with one another;
creating a unit positional information table associating port identification information indicating the communication port and the unit-installed position of the processing unit with each other based on the contents of the address learning table and the activation completion notification;
monitoring the link state of each of the communication ports, and when a change in the link state between the communication port and the processing unit is detected, creating an alarm notification containing the port identification information of the communication port whose link state is changed; and
deriving the unit-installed position of the processing unit connected to the communication port whose link state is changed, from the alarm notification and the unit positional information table.
